(19) United States
(12) Patent Application Publication
(10) Pub. No.: US 2026/0280121 A1
(43) Pub. Date: Sep. 17, 2026

(54) ANTENNA DEVICE

(71) Applicant: Industrial Technology Research Institute, Hsinchu (TW)

(72) Inventors: Liyang Tsai, Yilan County (TW); Bing Syun Li, Hsinchu City (TW); Kuang-Hui Shih, Tainan City (TW); Jane-Hway Liao, Hsinchu County (TW)

(73) Assignee: Industrial Technology Research Institute, Hsinchu (TW)

(21) Appl. No.: 19/439,432

(22) Filed: Jan. 4, 2026

Related U.S. Application Data
(60) Provisional application No. 63/745,799, filed on Jan. 16, 2025.

(51) Int. Cl. H01Q 3/40; H01Q 15/00

(52) U.S. Cl. CPC H01Q 3/40; H01Q 15/0006

(57) ABSTRACT

An antenna device includes a Butler matrix, a switch, and an antenna module. The Butler matrix includes an input terminal and an output terminal. The switch is connected to the input terminal. The antenna module includes an antenna unit, a first guide, and a second guide. The antenna unit is connected to the output terminal of the Butler matrix. The first guide is located on one side of the antenna unit. The second guide is located on the other side of the antenna unit. The antenna unit, the first guide, and the second guide are formed on a substrate.

### CROSS-REFERENCE TO RELATED APPLICATION

This application claims the priority benefit of U.S. provisional application Ser. No. 63/745,799, filed on Jan. 16, 2025. The entirety of the above-mentioned patent application is hereby incorporated by reference herein and made a part of this specification.

### TECHNICAL FIELD

The disclosure relates to an antenna device, and more particularly to a panel-level antenna device.

### BACKGROUND

Generally speaking, a Butler matrix may be used in a beamforming circuit, which may implement beam scanning and switching, and is widely applied to wireless communications and radar systems. However, the Butler matrix has a limited offset angle.

For example, a phased array may use the Butler matrix to replace a beamforming integrated circuit (BFIC) to connect antennas. The BFIC refers to an integrated circuit for implementing beamforming technology, is typically composed of multiple phase shifters, amplifiers, and radio frequency circuits, and is costly, especially in massive multiple-input multiple-output (MIMO) or millimeter wave (mmWave) communication applications. The BFIC requires a large number of radio frequency signal processing units to control the beam direction, resulting in an increase in overall energy consumption, which is not conducive to application in battery-powered equipment (for example, drones, autonomous vehicles, IoT equipment, etc.).

In addition, an antenna system integrating the BFIC may require additional circuit design, heat dissipation management, and power supply module, increasing design difficulty and cost.

### SUMMARY

An antenna device of the disclosure includes a Butler matrix, a switch, and an antenna module. The Butler matrix includes an input terminal and an output terminal. The switch is connected to the input terminal. The antenna module includes an antenna unit, a first guide, and a second guide. The antenna unit is connected to the output terminal of the Butler matrix. The first guide is located on one side of the antenna unit. The second guide is located on other side of the antenna unit. The antenna unit, the first guide, and the second guide are formed on a substrate.

In the antenna device of the disclosure, the Butler matrix is matched with the antenna module. The antenna module includes the antenna unit, the first guide, and the second guide. The first guide and the second guide respectively function as a reflector or a director to control the field pattern offset direction and increase beam flexibility.

Several exemplary embodiments accompanied with drawings are described in detail below to further describe the disclosure in detail.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a block schematic diagram of an antenna device according to an embodiment of the disclosure.

FIG. 2 is a schematic diagram of an architecture of an antenna device based on an 8×8 Butler matrix according to an embodiment of the disclosure.

FIG. 3 is a schematic diagram of an architecture of an antenna device according to an embodiment of the disclosure.

FIG. 4A is a schematic diagram of some elements of an antenna device according to an embodiment of the disclosure.

FIG. 4B is a cross-sectional schematic diagram of the antenna device of FIG. 4A.

FIG. 4C is a schematic diagram of a structure of a diode of FIG. 4A.

FIG. 4D is a cross-sectional schematic diagram of the diode of FIG. 4C along a section line L-L.

FIG. 4E is a cross-sectional schematic diagram of the diode of FIG. 4C along a section line L′-L′.

FIG. 5 is a schematic diagram of some elements of an antenna device according to an embodiment of the disclosure.

FIG. 6A is a schematic diagram of some elements of an antenna device according to an embodiment of the disclosure.

FIG. 6B is a cross-sectional schematic diagram of the antenna device of FIG. 6A.

FIG. 7A is a schematic diagram of some elements of an antenna device according to an embodiment of the disclosure.

FIG. 7B is a cross-sectional schematic diagram of the antenna device of FIG. 7A.

FIG. 8A is a schematic diagram of some elements of an antenna device according to an embodiment of the disclosure.

FIG. 8B is a cross-sectional schematic diagram of the antenna device of FIG. 8A.

FIG. 9 is a schematic diagram of an architecture of an antenna device according to an embodiment of the disclosure.

FIG. 10A is a schematic diagram of some elements of an antenna device according to an embodiment of the disclosure.

FIG. 10B is a cross-sectional schematic diagram of the antenna device of FIG. 10A.

FIG. 11A is a schematic diagram of some elements of an antenna device according to an embodiment of the disclosure.

FIG. 11B is a cross-sectional schematic diagram of the antenna device of FIG. 11A.

FIG. 12A is a schematic diagram of some elements of an antenna device according to an embodiment of the disclosure.

FIG. 12B is a cross-sectional schematic diagram of the antenna device of FIG. 12A.

FIG. 13A is a schematic diagram of some elements of an antenna device according to an embodiment of the disclosure.

FIG. 13B is a cross-sectional schematic diagram of the antenna device of FIG. 13A.

FIG. 14 is a schematic diagram of an architecture of an antenna device according to an embodiment of the disclosure.

FIG. 15A is a schematic diagram of some elements of an antenna device according to an embodiment of the disclosure.

FIG. 15B is a cross-sectional schematic diagram of the antenna device of FIG. 15A.

FIG. 16A is a schematic diagram of some elements of an antenna device according to an embodiment of the disclosure.

FIG. 16B is a cross-sectional schematic diagram of the antenna device of FIG. 16A.

### DETAILED DESCRIPTION OF DISCLOSURED EMBODIMENTS

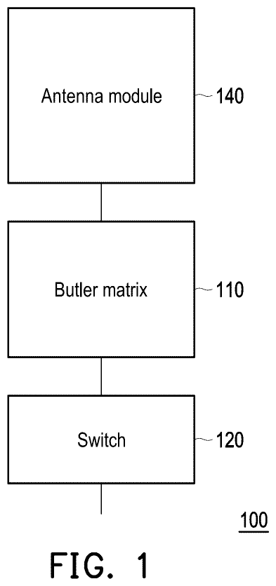

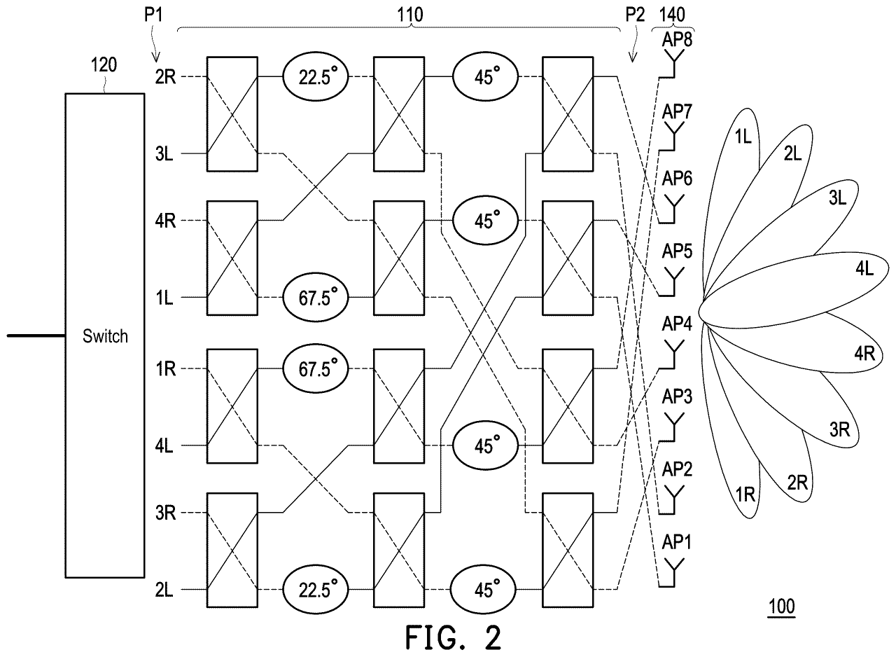

FIG. 1 is a block schematic diagram of an antenna device according to an embodiment of the disclosure. FIG. 2 is a schematic diagram of an architecture of an antenna device based on an 8×8 Butler matrix according to an embodiment of the disclosure. Please refer to FIG. 1 first. An antenna device 100 of the embodiment includes a Butler matrix 110, a switch 120, and an antenna module 140. Here, the antenna device 100 uses panel-level process technology to manufacture an antenna pattern and a diode, and related description will be subsequently described in detail.

Please refer to FIG. 2. In the embodiment, the Butler matrix 110 has, for example, an 8×8 architecture. However, in other embodiments, the Butler matrix 110 may also have a 4×4 architecture or a 16×16 architecture, but the disclosure is not limited thereto. In the embodiment, the switch 120 is, for example, single pole eight throw (SP8T) and includes a diode. Serving as a radio frequency switch for switching signals between 8 channels, the form of the switch 120 may be correspondingly adjusted to match the architecture of the Butler matrix, but the disclosure is not limited thereto.

In the embodiment, the Butler matrix 110 includes an input terminal P1 and an output terminal P2. The switch 120 is connected to the input terminal P1 of the Butler matrix for switching. The Butler matrix 110 is configured to feed input radio frequency signals into the antenna module 140 (for example, antenna ports AP1, AP2, AP3, AP4, AP5, AP6, AP7, and AP8) with different phase distributions, thereby controlling the direction of the main beam. Specifically, the Butler matrix 110 generates an output with a specific phase difference for each input port. After feeding into the antenna module 140 (for example, the antenna ports AP1, AP2, AP3, AP4, AP5, AP6, AP7, and AP8), a radiation pattern with the main beam directed toward a specific direction may be formed. FIG. 2 schematically illustrates the circuit of the Butler matrix 110. In other embodiments, the circuit connection and the element configuration of the Butler matrix are not limited thereto. In addition, FIG. 2 omits the illustration of a guide. The guide will be described in detail in subsequent drawings.

Other embodiments are listed below for illustration. It must be noted here that the following embodiments continue to use the reference numerals and some content of the previous embodiment, wherein the same numerals are adopted to represent the same or similar elements, and the description of the same technical content is omitted. Reference may be made to the previous embodiment for the description of the omitted part, which will not be repeated in the following embodiments.

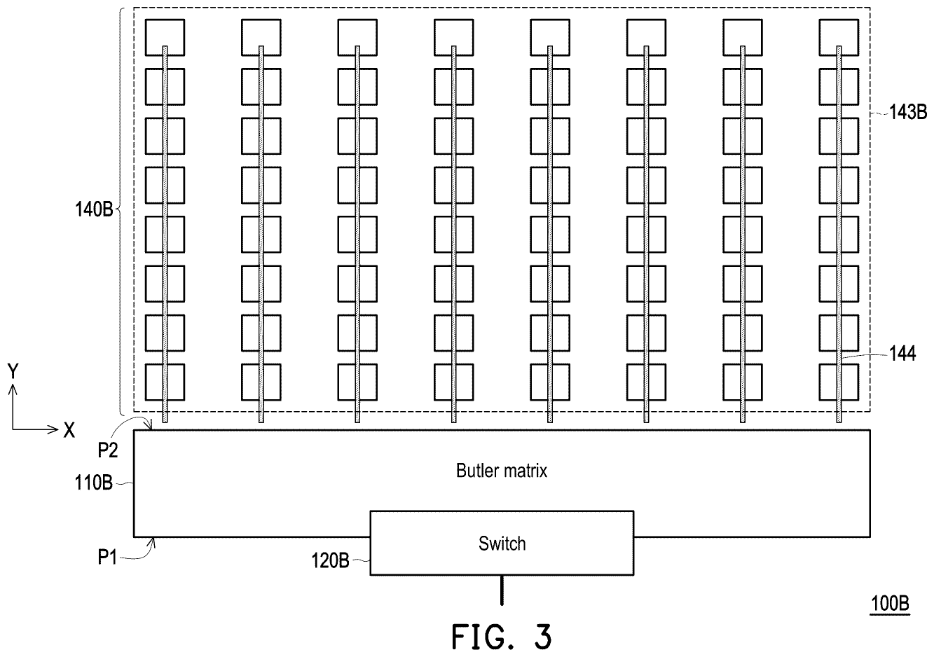

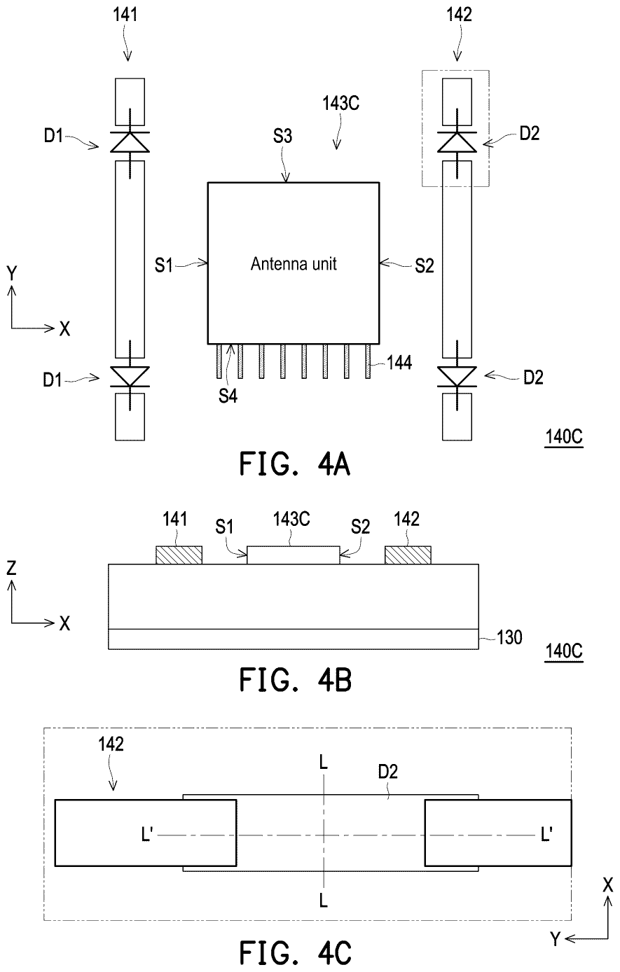

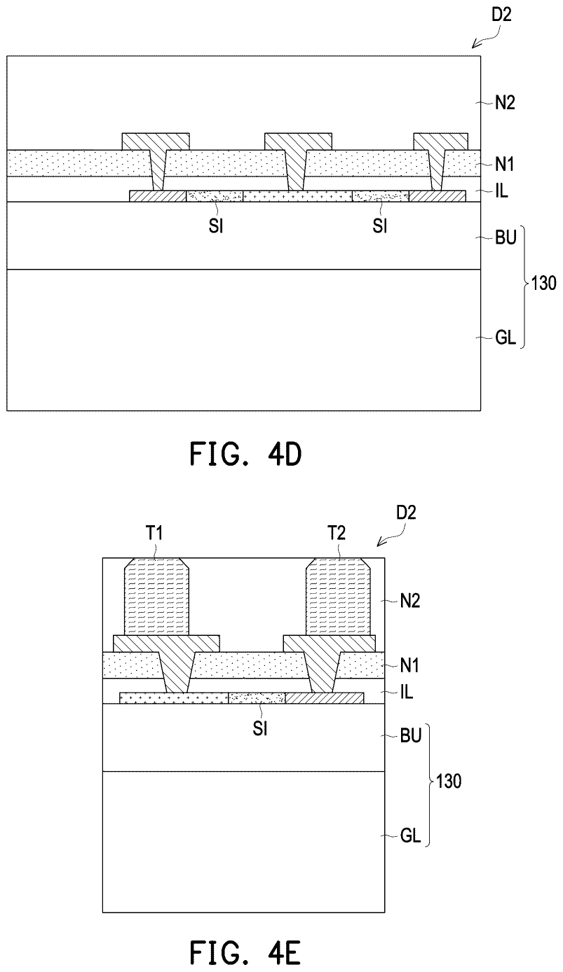

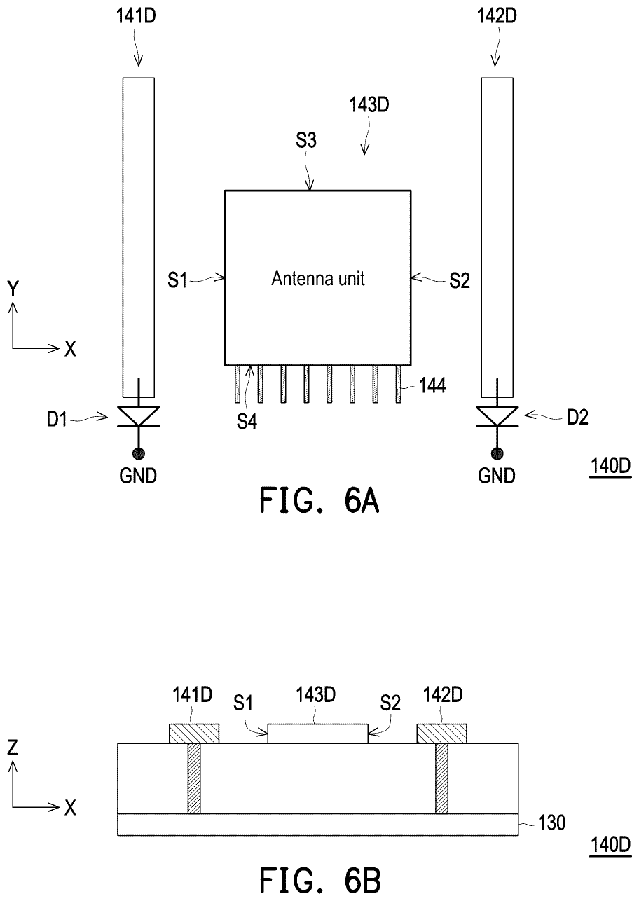

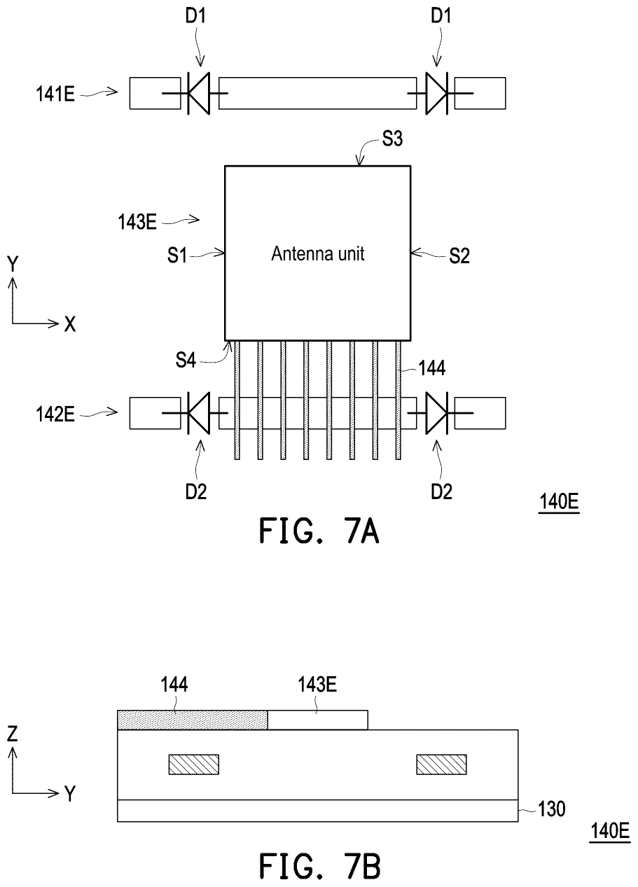

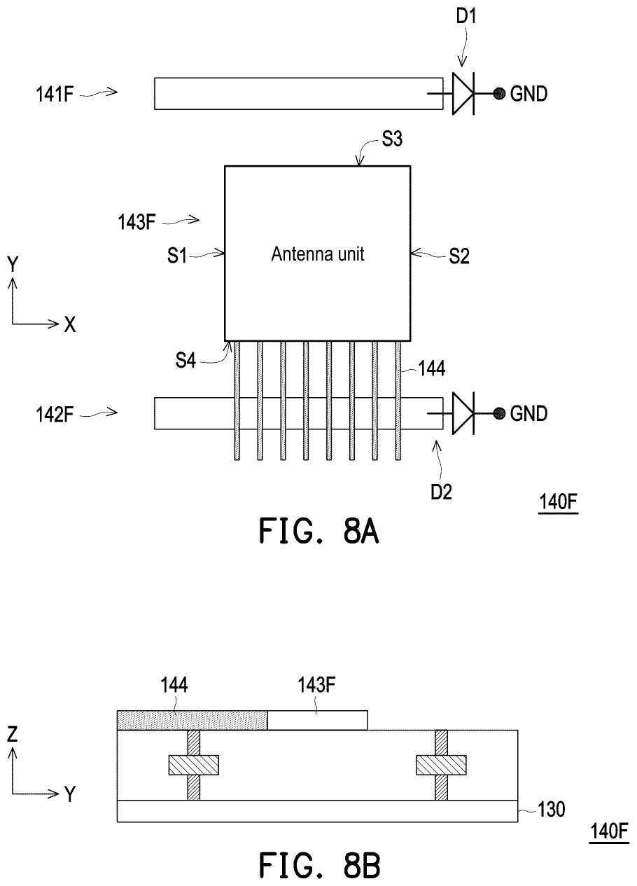

FIG. 3 is a schematic diagram of an architecture of an antenna device according to an embodiment of the disclosure. FIG. 3 schematically illustrates a Butler matrix 110B with blocks. Reference may be made to the Butler matrix 110 of FIG. 2 for the operation and the implementation of the Butler matrix 110B, which is not limited by the disclosure. FIG. 3 omits the illustration of a guide. For various configurations of the guide around the antenna unit, reference may be made to FIG. 4A, FIG. 6A, FIG. 7A, and FIG. 8A.

Please refer to FIG. 3. In the embodiment, an antenna device 100B includes a Butler matrix 110B, a switch 120B, and an antenna module 140B. The antenna module 140B includes an antenna unit 143B. The antenna unit 143B is connected to an output terminal P2 of the Butler matrix 110B through a serial network 144. Here, the antenna unit 143B is a serial array antenna, such as an 8×8 antenna array, but not limited thereto. In other embodiments, the antenna unit may also have a 1×1 antenna configuration, such as a patch antenna or a dipole antenna, but the disclosure is not limited thereto.

In the embodiment, the antenna unit 143B refers to the entire antenna array in the dotted box. However, in other embodiments, the antenna unit may also refer to at least one column or at least one antenna in the array antenna, but the disclosure is not limited thereto.

FIG. 4A is a schematic diagram of some elements of an antenna device according to an embodiment of the disclosure. FIG. 4B is a cross-sectional schematic diagram of the antenna device of FIG. 4A. FIG. 4A and FIG. 4B schematically illustrate simply relative positions of elements for reference only. Some structures are omitted to facilitate display and identification of component parts to be described. The actual dimensional ratio is not limited thereto.

Please refer to FIG. 4A and FIG. 4B. In the embodiment, an antenna module 140C includes an antenna unit 143C. For clarity, FIG. 4A schematically illustrates the antenna unit 143C as a single block. In an embodiment, the antenna unit 143C is the antenna unit 143B shown in FIG. 3. In other words, the antenna unit 143C is actually the entire serial array antenna.

In the embodiment, a first guide 141 is located on one side of the antenna unit 143C, and a second guide 142 is located on the other side of the antenna unit 143C. Specifically, the antenna unit 143C has a first side S1 and a second side S2 opposite to each other and a third side S3 and a fourth side S4 opposite to each other. The first guide 141 is located on the first side S1, the second guide 142 is located on the second side S2, and the antenna unit 143C is connected to the output terminal P2 of the Butler matrix 110 shown in FIG. 3 through the serial network 144 located on the fourth side S4.

In the embodiment, the first guide 141 includes a first switch portion D1. The first guide 141 may function as a director when the first switch portion D1 is not conducting and may function as a reflector when the first switch portion D1 is conducting. Here, the number of the first switch portions D1 is two, but not limited thereto.

In the embodiment, the second guide 142 includes a second switch portion D2. The second guide 142 may function as a director when the second switch portion D2 is not conducting and may function as a reflector when the second switch portion D2 is conducting. Here, the number of the second switch portions D2 is two, but not limited thereto.

Here, the first switch portion D1 and the second switch portion D2 are PIN diodes. However, in other embodiments, the first switch portion and the second switch portion may also be varactor diodes, but the disclosure is not limited thereto.

In this way, the first guide 141 and the second guide 142 may use the first switch portion D1 and the second switch portion D2 to change the lengths of the guides, so that the first guide 141 and the second guide 142 may function as the reflector or the director, further fine-tuning the beam offset angle, increasing beam flexibility. For example, if the angle controlled by the Butler matrix 110 is 30°, the angle may be further fine-tuned to 30±2°~±6° through the guide, so that beam control is more flexible, but the disclosure is not limited thereto.

In an embodiment, the Butler matrix 110 shown in FIG. 3 is adapted to control a beam in first axial direction (for example, X-axis), and the first guide 141 and the second guide 142 are arranged in the first axial direction (for example, X-axis), Therefore, the Butler matrix 110 controls the one-dimensional axial direction (for example, X-axis direction) beamforming effect, and the first guide 141 and the second guide 142 may increase or decrease the one-dimensional axial direction (for example, X-axis direction) beamforming angle. For example, the Butler matrix 110 controls the angle to be n degrees, and the first guide 141 and the second guide 142 may further increase or decrease the deflection angle to be n+2~6 degrees or n−2~6 degrees, but the disclosure is not limited thereto.

In an embodiment, when the first switch portion D1 of the first conductor 141 is conducting to function as the reflector and the length thereof is long, and the second switch portion D2 of the second conductor 142 is conducting to function as the reflector and the length thereof is long, there is no offset.

In an embodiment, when the first switch portion D1 of the first guide 141 is conducting to function as the reflector and the length thereof is long, and the second switch portion D2 of the second guide 142 is not conducting to function as the director and the length thereof is short, there is offset toward the +X-axis direction.

In an embodiment, when the first switch portion D1 of the first guide 141 is not conducting to function as the director and the length thereof is short, and the second switch portion D2 of the second guide 142 is conducting to function as the reflector and the length thereof is long, there is offset toward the-X-axis direction.

In an embodiment, when the first switch portion D1 of the first conductor 141 is not conducting to function as the director and the length thereof is short, and the second switch portion D2 of the second conductor 142 is not conducting to function as the director and the length thereof is short, there is no offset.

Under the above configuration, one antenna unit is configured with 2 guides, using the matching of the two guides to generate four modes, thereby controlling the field pattern offset direction. The phased array uses the Butler matrix to connect the antennas, eliminating the need for expensive and power-consuming BFIC elements. The field pattern offset direction may be controlled by simply changing the port of the input signal.

A diode in FIG. 4A is illustrated as a circuit symbol, but the diode and the antenna unit 143C are actually manufactured by panel-level process technology. As shown in FIG. 4B, the antenna module 140C is double-layered and is of floating type. The antenna unit 143C, the first guide 141, and the second guide 142 are formed on a substrate 130. The substrate 130 is a glass substrate.

FIG. 4C is a schematic diagram of a structure of the diode of FIG. 4A. FIG. 4D is a cross-sectional schematic diagram of the diode of FIG. 4C along a section line L-L. FIG. 4E is a cross-sectional schematic diagram of the diode of FIG. 4C along a section line L′-L′. Since the guides on the left and right sides are actually the same, the following description will be made using one of the guides as an example. FIG. 4C to FIG. 4E schematically illustrate simply relative positions of elements for reference only. Some structures are omitted to facilitate display and identification of component parts to be described. The actual dimensional ratio is not limited thereto.

Please refer to FIG. 4C to FIG. 4E. In an embodiment, a panel-level diode is designed using a polysilicon thin film process, a suitable substrate material (for example, glass, but not limited thereto) is prepared, and an integrated copper process is used to complete manufacture of an antenna and a transmission line. For example, a buffer layer BU is provided on a glass layer GL, and a material thereof includes silicon oxide (SiOx), silicon nitride (SiNx), etc. Polysilicon SI and an interlayer dielectric (ILD) layer IL are provided on the buffer layer BU. The polysilicon SI functions as a semiconductor active layer of an element to control signal switching. The material of the interlayer dielectric layer IL includes, for example, silicon oxide (SiOx) to isolate different metal wires, prevent short circuit, and provide electrical insulation. A film layer N1 is provided on the interlayer dielectric layer IL, and a material thereof includes, for example, silicon nitride (SiNx). A redistribution layer (RDL) N2 is provided on the film layer N1. An anode T1 and a cathode T2 of the diode are copper electroplated to fill the holes of the RDL and form copper wires. The anode T1 and the cathode T2 are respectively electrically conducted to different metal wires of the interlayer dielectric layer IL. The RDL is then removed, leaving only the copper wires on the dielectric layer (N1). Under the above configuration, the antenna and the diode of the embodiment are manufactured using panel-level process technology.

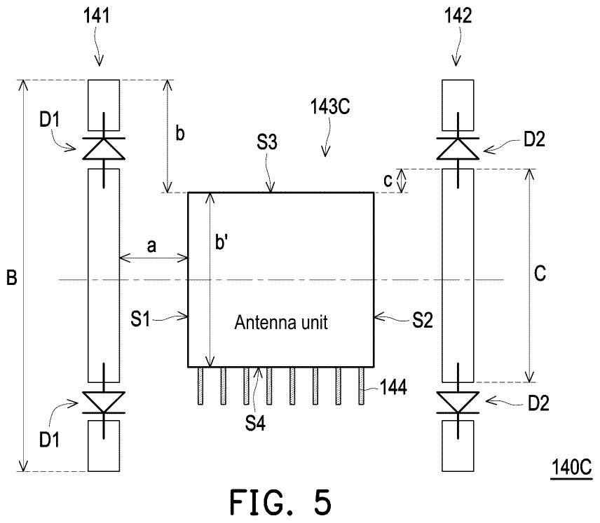

FIG. 5 is a schematic diagram of some elements of an antenna device according to an embodiment of the disclosure. Please refer to FIG. 5. In an embodiment, a range of a dimension a is 0.1~0.17 λg, representing the distance between the guide and the unit. A range of a dimension b is 0.09~0.15 λg, and B =b'+2b is the length as the reflector. A range of a dimension c is −0.07~0.04 λg, and C =b'+2c is the length as the director, where λg is the wavelength in the medium and is related to the frequency and the medium. For example, the medium is glass, a=2 mm (0.143 λg), b=1.75 mm (0.125 λg), c=0.5 mm (0.035 λg), and b′=6.5 mm, but the disclosure is not limited thereto.

FIG. 6A is a schematic diagram of some elements of an antenna device according to an embodiment of the disclosure. FIG. 6B is a cross-sectional schematic diagram of the antenna device of FIG. 6A. FIG. 6A and FIG. 6B schematically illustrate simply relative positions of elements for reference only. Some structures are omitted to facilitate display and identification of component parts to be described. The actual dimensional ratio is not limited thereto. A diode of FIG. 6A is shown as a circuit symbol, but the diode and the antenna unit are actually manufactured using panel-level process technology.

Please refer to FIG. 6A and FIG. 6B. In the embodiment, an antenna module 140D includes an antenna unit 143D. For clarity, FIG. 6A schematically illustrates the antenna unit 143D as a single block. In fact, the antenna unit 143D is the antenna unit 143B shown in FIG. 3. In other words, the antenna unit 143D represents the entire serial array antenna in an embodiment.

In the embodiment, the antenna module 140D is slightly different from the antenna module 140C of FIG. 4A. The main difference is that the antenna module 140D is grounded, and the diode is connected to a reference ground voltage GND, but not limited thereto.

In an embodiment, when a first guide 141D is grounded to function as the reflector and a second guide 142D is grounded to function as the reflector, there is no offset.

In an embodiment, when the first guide 141D is grounded to function as the reflector and the second guide 142D is open to function as the director, there is offset toward the +X-axis direction.

In an embodiment, when the first guide 141D is open to function as the director and the second guide 142D is grounded to function as the reflector, there is offset toward the-X-axis direction.

In an embodiment, when the first guide 141D is grounded to function as the director and the second guide 142D is open to function as the director, there is no offset.

FIG. 7A is a schematic diagram of some elements of an antenna device according to an embodiment of the disclosure. FIG. 7B is a cross-sectional schematic diagram of the antenna device of FIG. 7A. FIG. 7A and FIG. 7B schematically illustrate simply relative positions of elements for reference only. Some structures are omitted to facilitate display and identification of component parts to be described. The actual dimensional ratio is not limited thereto.

Please refer to FIG. 7A and FIG. 7B. In the embodiment, an antenna module 140E is slightly different from the antenna module 140C of FIG. 4A. The main difference is that a first guide 141E is located on the third side S3 and a second guide 142E is located on the fourth side S4. An antenna unit 143E is connected to the output terminal P2 of the Butler matrix 110 shown in FIG. 3 through the serial network 144 located at the fourth side S4.

In an embodiment, the Butler matrix 110 shown in FIG. 3 is adapted to control the beam in the first axial direction (for example, X-axis). The first guide 141E and the second guide 142E are arranged in a second axial direction (for example, Y-axis). The second axial direction (for example, Y-axis) is perpendicular to the first axial direction (for example, X-axis). The first guide 141E and the second guide 142E are adapted to control a beam in the second axial direction (for example, Y-axis). Therefore, the Butler matrix 110 controls the one-dimensional axial direction (X-axis direction) beamforming effect, and the first guide 141E and the second guide 142E may optionally increase the deflection angle by +2~+6 degrees or decrease by −2~−6 degrees in the Y-axis direction, so that the one-dimensional phased array antenna can have the beamforming effect of a two-dimensional axial direction field pattern. In the embodiment, the Butler matrix with 8 ports originally has 8 angle options. If the guide is added, two options may be added for each angle, so 16 angle options may be added, resulting in a total of 24 options.

In an embodiment, when the first guide 141E is conducting to function as the reflector and the length thereof is long, and the second guide 142E is conducting to function as the reflector and the length thereof is long, there is no offset.

In an embodiment, when the first guide 141E is conducting to function as the reflector and the length thereof is long, and the second guide 142E is not conducting to function as the director and the length thereof is short, there is offset toward the −Y-axis direction.

In an embodiment, when the first guide 141E is not conducting to function as the director and the length thereof is short, and the second guide 142E is conducting to function as the reflector and the length thereof is long, there is offset toward the +Y-axis direction.

In an embodiment, when the first guide 141E is not conducting to function as the director and the length thereof is short, and the second guide 142E is not conducting to function as the director and the length thereof is short, there is no offset.

It should be noted that a diode in FIG. 7A is illustrated as a circuit symbol, but the diode and the antenna unit 143E are actually manufactured using panel-level process technology. As shown in FIG. 7B, the antenna module 140E is triple-layered and is of floating type.

FIG. 8A is a schematic diagram of some elements of an antenna device according to an embodiment of the disclosure. FIG. 8B is a cross-sectional schematic diagram of the antenna device of FIG. 8A. FIG. 8A and FIG. 8B schematically illustrate simply relative positions of elements for reference only. Some structures are omitted to facilitate display and identification of component parts to be described. The actual dimensional ratio is not limited thereto. A diode of FIG. 8A is shown as a circuit symbol, but the diode and the antenna unit are actually manufactured using panel-level process technology.

Please refer to FIG. 8A and FIG. 8B. In the embodiment, an antenna module 140F includes an antenna unit 143F. For clarity, FIG. 8A schematically illustrates the antenna unit 143F as a single block. In an embodiment, the antenna unit 143F is the antenna unit 143B shown in FIG. 3. In other words, the antenna unit 143F actually represents the entire serial array antenna.

In the embodiment, the antenna module 140F is slightly different from the antenna module 140C of FIG. 7A. The main difference is that the antenna module 140F is grounded.

In an embodiment, when a first guide 141F is grounded to function as the reflector and second guide 142F is grounded to function as the reflector, there is no offset.

In an embodiment, when the first guide 141F is grounded to function as the reflector and the second guide 142F is open to function as the director, there is offset toward the −Y-axis direction.

In an embodiment, when the first guide 141F is open to function as the director and the second guide 142F is grounded to function as the reflector, there is offset toward the +Y-axis direction.

In an embodiment, when the first guide 141F is grounded to function as the director and the second guide 142F is open to function as the director, there is no offset.

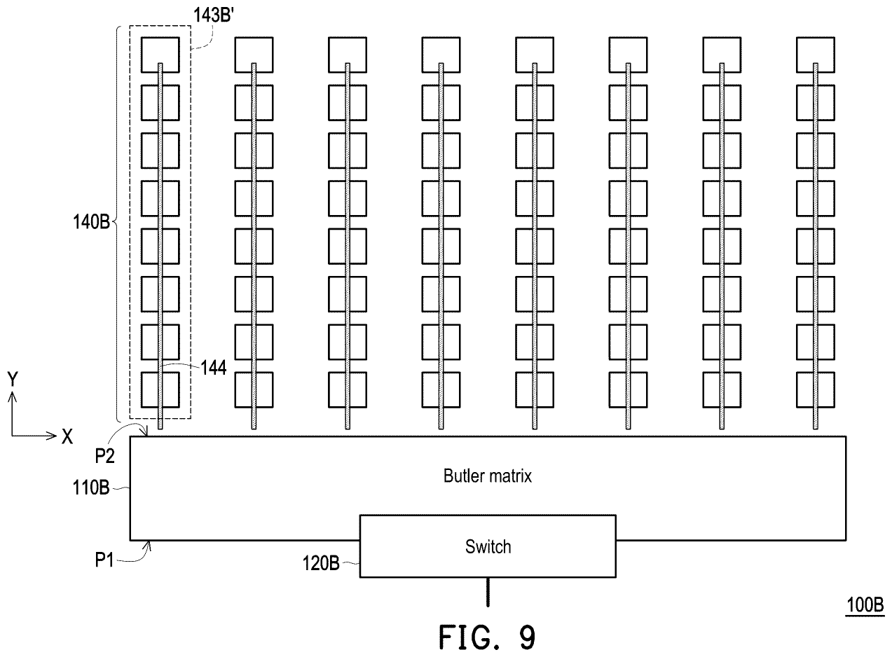

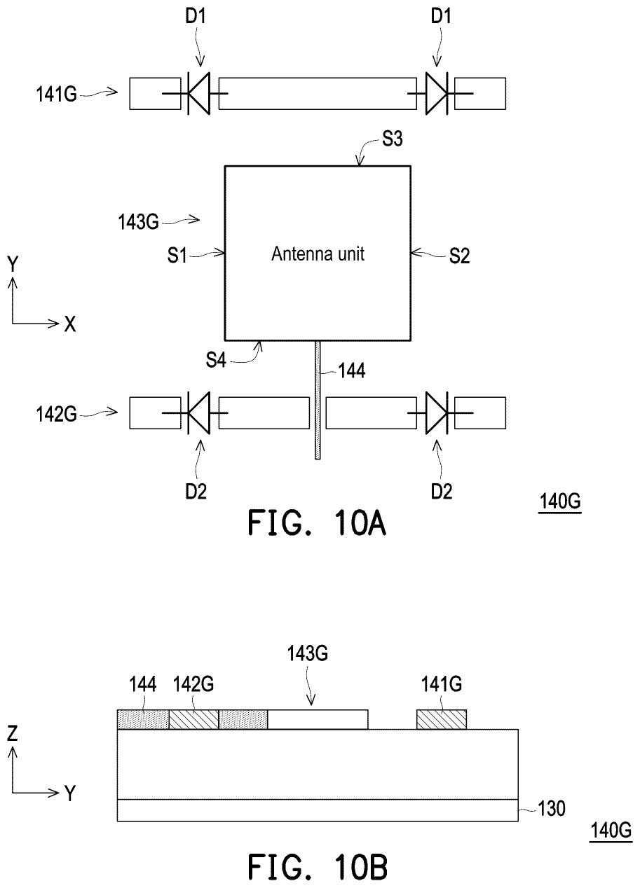

FIG. 9 is a schematic diagram of an architecture of an antenna device according to an embodiment of the disclosure. FIG. 10A is a schematic diagram of some elements of an antenna device according to an embodiment of the disclosure. FIG. 10B is a cross-sectional schematic diagram of the antenna device of FIG. 10A. FIG. 10A and FIG. 10B schematically illustrate simply relative positions of elements for reference only. Some structures are omitted to facilitate display and identification of component parts to be described. The actual dimensional ratio is not limited thereto.

Please refer to FIG. 9 first. In the embodiment, an antenna unit 143B′ refers to at least one column in an antenna array.

Please refer to FIG. 10A and FIG. 10B. In the embodiment, an antenna module 140G includes an antenna unit 143G. For clarity, FIG. 10A schematically illustrates the antenna unit 143G as a single block. In an embodiment, the antenna unit 143G is the antenna unit 143B′ shown in FIG. 9. The antenna unit 143G is actually the at least one column in the antenna array. In other words, the guides are not necessarily configured on opposite sides of the entire antenna array, but may be configured on opposite sides of the at least one column of the antenna array, but the disclosure is not limited thereto.

In the embodiment, a first guide 141G is located on the third side S3 and a second guide 142G is located on the fourth side S4. The antenna unit 143G is connected to the output terminal P2 of the Butler matrix 110 shown in FIG. 9 through the serial network 144 located on the fourth side S4.

In an embodiment, the Butler matrix 110 shown in FIG. 9 is adapted to control the beam in the first axial direction (for example, X-axis). The first guide 141G and the second guide 142G are arranged in the second axial direction (for example, Y-axis). The second axial direction is perpendicular to the first axial direction. The first guide 141G and the second guide 142G are adapted to control the beam in the second axial direction (for example, Y-axis). Therefore, the Butler matrix 110 controls the one-dimensional axial direction (X-axis direction) beamforming effect, and the first guide 141G and the second guide 142G may optionally increase the deflection angle by +2~+6 degrees or decrease by −2~−6 degrees in the Y-axis direction, so that the one-dimensional phased array antenna can have the beamforming effect of a two-dimensional axial direction field pattern.

In an embodiment, when the first guide 141G is conducting to function as the reflector and the length thereof is long, and the second guide 142G is conducting to function as the reflector and the length thereof is long, there is no offset.

In an embodiment, when the first guide 141G is conducting to function as the reflector and the length thereof is long, and the second guide 142G is not conducting to function as the director and the length thereof is short, there is offset toward the −Y-axis direction.

In an embodiment, when the first guide 141G is not conducting to function as the director and the length thereof is short, and the second guide 142G is conducting to function as the reflector and the length thereof is long, there is offset toward the +Y-axis direction.

In an embodiment, when the first guide 141G is not conducting to function as the director and the length thereof is short, and the second guide 142G is not conducting to function as the director and the length thereof is short, there is no offset.

A diode of FIG. 10A is illustrated as a circuit symbol, but the diode and the antenna unit 143G are actually manufactured using panel-level process technology. As shown in FIG. 10B, the antenna module 140G is double-layered and is of floating type. The antenna unit 143G, the first guide 141G, and the second guide 142G are formed on the substrate 130. The substrate 130 is a glass substrate.

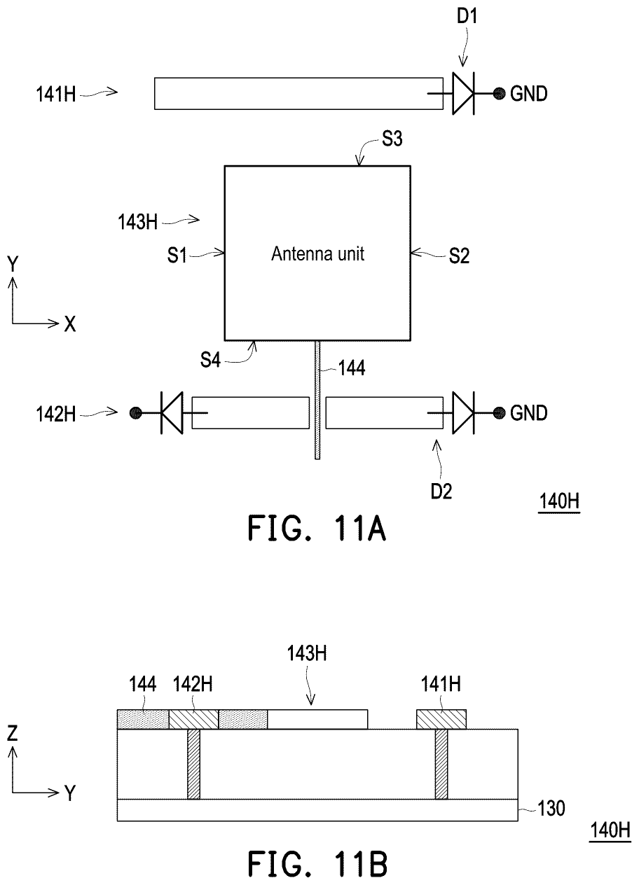

FIG. 11A is a schematic diagram of some elements of an antenna device according to an embodiment of the disclosure. FIG. 11B is a cross-sectional schematic diagram of the antenna device of FIG. 11A. FIG. 11A and FIG. 11B schematically illustrate simply relative positions of elements for reference only. Some structures are omitted to facilitate display and identification of component parts to be described. The actual dimensional ratio is not limited thereto. A diode of FIG. 11A is shown as a circuit symbol, but the diode and the antenna unit are actually manufactured using panel-level process technology.

Please refer to FIG. 11A and FIG. 11B. In the embodiment, an antenna module 140H includes an antenna unit 143H. For clarity, FIG. 11A schematically illustrates the antenna unit 143H as a single block. In an embodiment, the antenna unit 143H is the antenna unit 143B′ shown in FIG. 9. The antenna unit 143H is actually the at least one column in the antenna array.

In the embodiment, the antenna module 140H is slightly different from the antenna module 140G of FIG. 10A. The main difference is that the antenna module 140H is grounded.

In an embodiment, when a first guide 141H is grounded to function as the reflector and a second guide 142H is grounded to function as the reflector, there is no offset.

In an embodiment, when the first guide 141H is grounded to function as the reflector and the second guide 142H is open to function as the director, there is offset toward the −Y-axis direction.

In an embodiment, when the first guide 141H is open to function as the director and the second guide 142H is grounded to function as the reflector, there is offset toward the +Y-axis direction.

In an embodiment, when the first guide 141H is grounded to function as the director and the second guide 142H is open to function as the director, there is no offset.

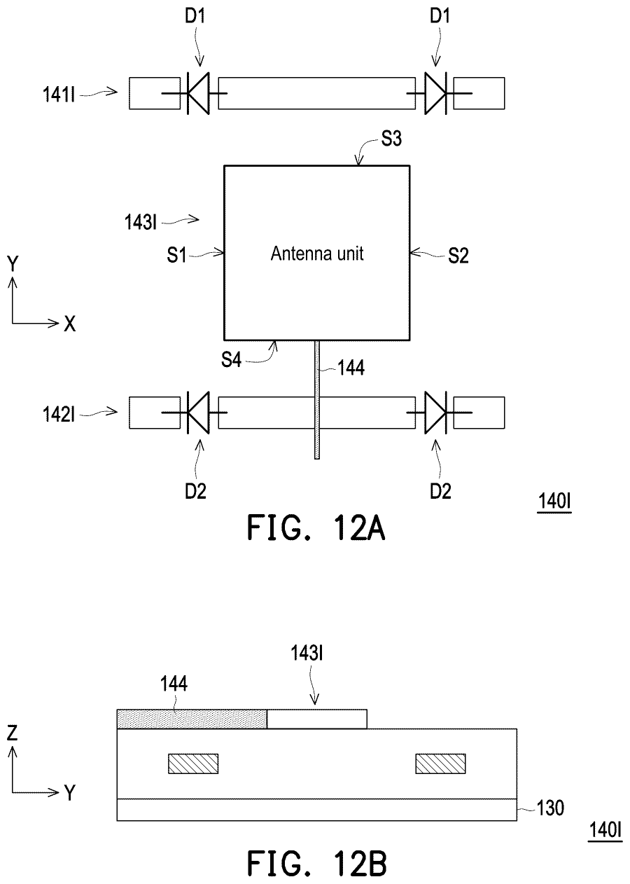

FIG. 12A is a schematic diagram of some elements of an antenna device according to an embodiment of the disclosure. FIG. 12B is a cross-sectional schematic diagram of the antenna device of FIG. 12A. FIG. 12A and FIG. 12B schematically illustrate simply relative positions of elements for reference only. Some structures are omitted to facilitate display and identification of component parts to be described. The actual dimensional ratio is not limited thereto.

In the embodiment, an antenna module 140I is slightly different from the antenna module 140G of FIG. 10A. The main difference is that the antenna module 140I is triple-layered and is of floating type.

In an embodiment, when a first guide 141I is conducting to function as the reflector and the length thereof is long, and a second guide 142I is conducting to function as the reflector and the length thereof is long, there is no offset.

In an embodiment, when the first guide 141I is conducting to function as the reflector and the length thereof is long, and the second guide 142I is not conducting to function as the director and the length thereof is short, there is offset toward the −Y-axis direction.

In an embodiment, when the first guide 141I is not conducting to function as the director and the length thereof is short, and the second guide 142I is conducting to function as the reflector and the length thereof is long, there is offset toward the +Y-axis direction.

In an embodiment, when the first guide 141I is not conducting to function as the director and the length thereof is short, and the second guide 142I is not conducting to function as the director and the length thereof is short, there is no offset.

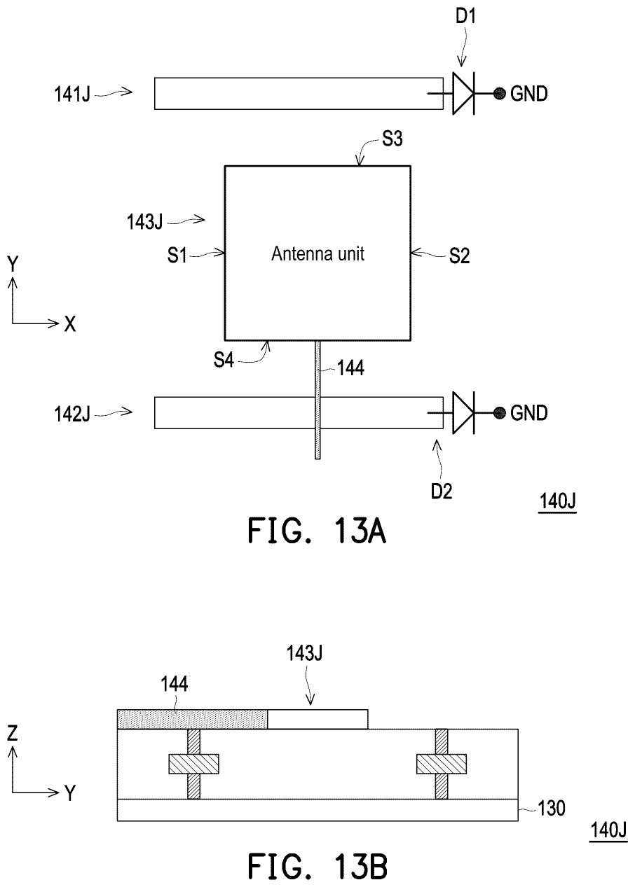

FIG. 13A is a schematic diagram of some elements of an antenna device according to an embodiment of the disclosure. FIG. 13B is a cross-sectional schematic diagram of the antenna device of FIG. 13A. FIG. 13A and FIG. 13B schematically illustrate simply relative positions of elements for reference only. Some structures are omitted to facilitate display and identification of component parts to be described. The actual dimensional ratio is not limited thereto. A diode of FIG. 13A is shown as a circuit symbol, but the diode and the antenna unit are actually manufactured using panel-level process technology.

Please refer to FIG. 13A and FIG. 13B. In the embodiment, an antenna module 140J is slightly different from the antenna module 140I of FIG. 12A. The main difference is that the antenna module 140J is grounded.

In an embodiment, when a first guide 141J is grounded to function as the reflector and a second guide 142J is grounded to function as the reflector, there is no offset.

In an embodiment, when the first guide 141J is grounded to function as the reflector and the second guide 142J is open to function as the director, there is offset toward the −Y-axis direction.

In an embodiment, when the first guide 141J is open to function as the director and the second guide 142J is grounded to function as the reflector, there is offset toward the +Y-axis direction.

In an embodiment, when the first guide 141J is grounded to function as the director and the second guide 142J is open to function as the director, there is no offset.

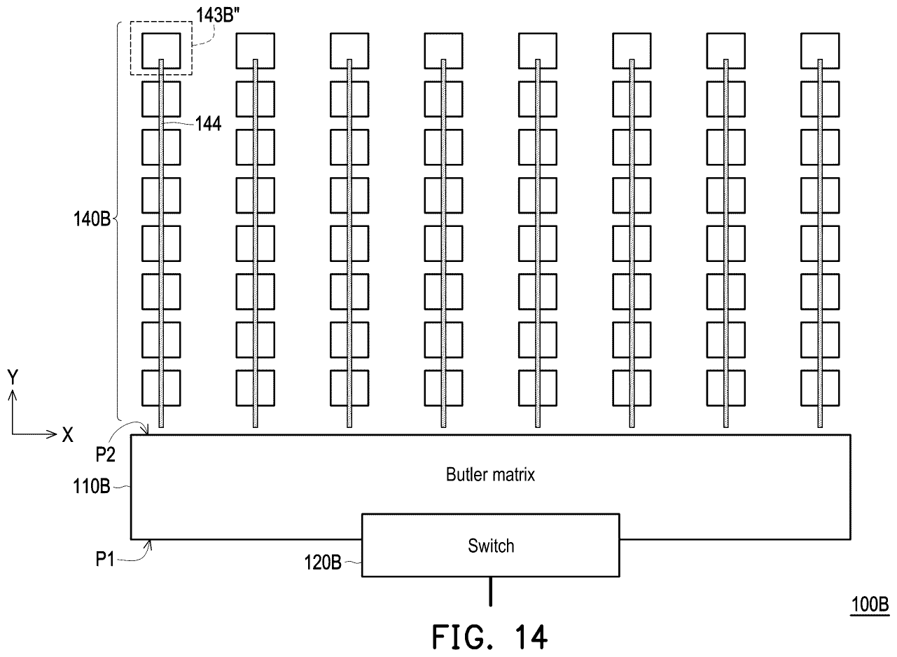

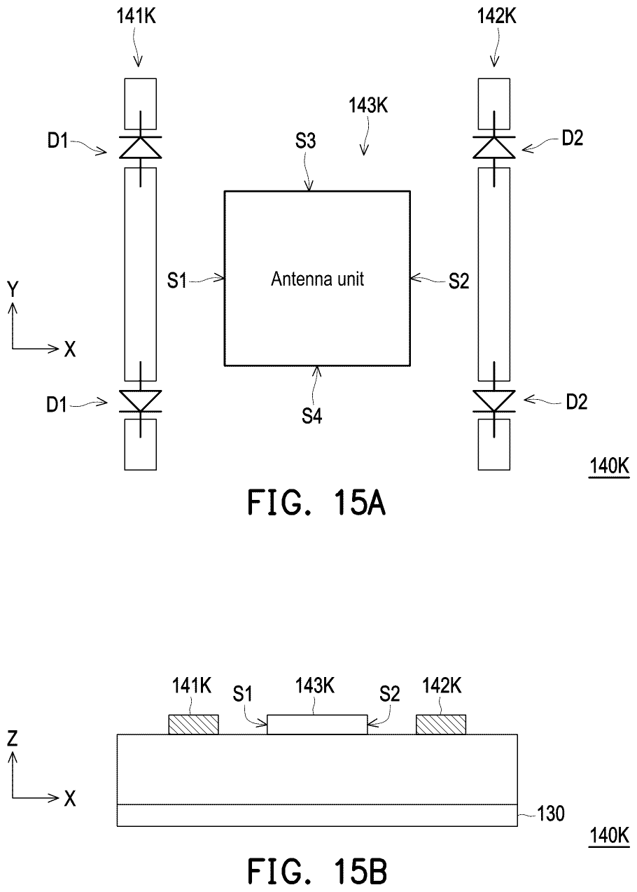

FIG. 14 is a schematic diagram of an architecture of an antenna device according to an embodiment of the disclosure. FIG. 15A is a schematic diagram of some elements of an antenna device according to an embodiment of the disclosure. FIG. 15B is a cross-sectional schematic diagram of the antenna device of FIG. 15A. FIG. 15A and FIG. 15B schematically illustrate simply relative positions of elements for reference only. Some structures are omitted to facilitate display and identification of component parts to be described. The actual dimensional ratio is not limited thereto.

Please refer to FIG. 14 first. In the embodiment, an antenna unit 143B″ refers to at least one antenna body in an antenna array.

Please refer to FIG. 15A and FIG. 15B. In the embodiment, an antenna module 140K includes an antenna unit 143K. For clarity, FIG. 15A schematically illustrates the antenna unit 143K as a single block. In an embodiment, the antenna unit 143K is the antenna unit 143B″ shown in FIG. 14. The antenna unit 143K is actually the at least one antenna body in the antenna array. In other words, the guides are not necessarily configured on opposite sides of the entire antenna array, but may be configured on opposite sides of each antenna body (64 antenna bodies are shown in FIG. 14) of the antenna array, but the disclosure is not limited thereto.

In an embodiment, the Butler matrix 110 shown in FIG. 14 is adapted to control the beam in the first axial direction (for example, X-axis), and a first guide 141K and a second guide 142K are arranged in the first axial direction (for example, X-axis).

Therefore, the Butler matrix 110 controls the one-dimensional axial direction (X-axis direction) beamforming effect, and the first guide 141K and the second guide 142K may increase or decrease the one-dimensional axial direction (X-axis direction) beamforming angle. For example, the Butler matrix 110 controls the angle to be n degrees, and the first guide 141K and the second guide 142K may further increase or decrease the deflection angle to be n+2~6 degrees or n−2~6 degrees, but the disclosure is not limited thereto.

In an embodiment, when the first guide 141K is conducting to function as the reflector and the length thereof is long, and the second guide 142K is conducting to function as the reflector and the length thereof is long, there is no offset.

In an embodiment, when the first guide 141K is conducting to function as the reflector and the length thereof is long, and the second guide 142K is not conducting to function as the director and the length thereof is short, there is offset toward the +X-axis direction. In an embodiment, when the first guide 141K is not conducting to function as the director and the length thereof is short, and the second guide 142K is conducting to function as the reflector and the length thereof is long, there is offset toward the −X-axis direction. In an embodiment, when the first guide 141K is not conducting to function as the director and the length thereof is short, and the second guide 142K is not conducting to function as the director and the length thereof is short, there is no offset.

It should be noted that a diode of FIG. 15A is illustrated as a circuit symbol, but the diode and an antenna unit 143J are actually manufactured using panel-level process technology. As shown in FIG. 15B, the antenna module 140K is double-layered and is of floating type. The antenna unit 143K, the first guide 141K, and the second guide 142K are formed on the substrate 130. The substrate 130 is a glass substrate.

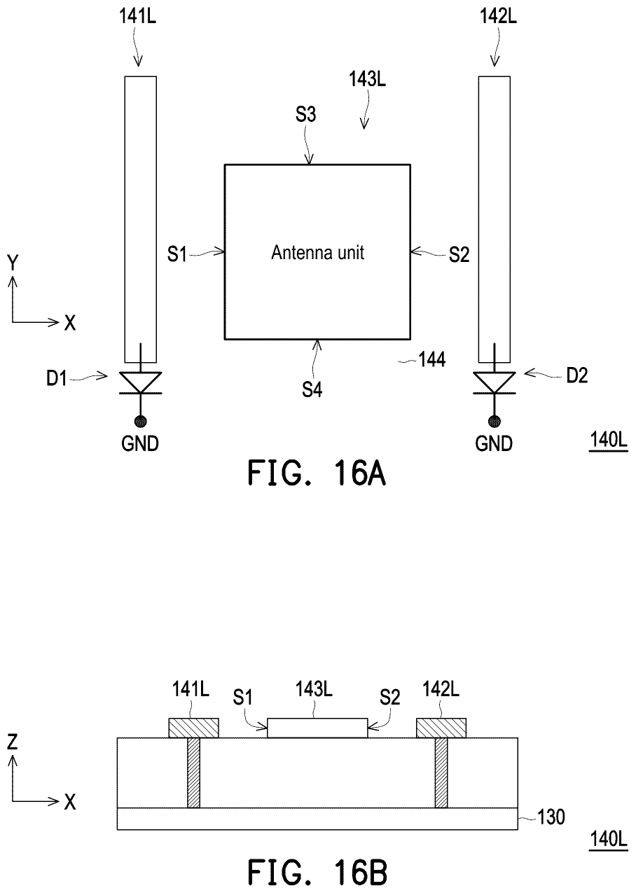

FIG. 16A is a schematic diagram of some elements of an antenna device according to an embodiment of the disclosure. FIG. 16B is a cross-sectional schematic diagram of the antenna device of FIG. 16A. FIG. 16A and FIG. 16B schematically illustrate simply relative positions of elements for reference only. Some structures are omitted to facilitate display and identification of component parts to be described. The actual dimensional ratio is not limited thereto. A diode of FIG. 16A is shown as a circuit symbol, but the diode and the antenna unit are actually manufactured using panel-level process technology.

Please refer to FIG. 16A and FIG. 16B. In the embodiment, an antenna module 140L is slightly different from the antenna module 140K of FIG. 15A. The main difference is that the antenna module 140L is grounded.

In an embodiment, when the first guide 141L is grounded to function as the reflector and the second guide 142L is grounded to function as the reflector, there is no offset. In an embodiment, when the first guide 141L is grounded to function as the reflector and the second guide 142L is open to function as the director, there is offset toward the +X-axis direction. In an embodiment, when the first guide 141L is open to function as the director and the second guide 142L is grounded to function as the reflector, there is offset toward the −X-axis direction. In an embodiment, when the first guide 141L is grounded to function as the director and the second guide 142L is open to function as the director, there is no offset.

In summary, in the antenna device of the disclosure, the Butler matrix is matched with the antenna module. The antenna module includes the antenna unit and a pair of guides, and t diodes are used to switch the length of the guides, turning the guides into the reflector or the director, controlling the field pattern offset direction, and increasing beam flexibility. In this way, the Butler matrix controls the beam direction through the passive circuit combination, eliminating the need for expensive BFIC, which can effectively reduce cost and power consumption to facilitate application in battery-powered equipment (for example, drones, autonomous vehicles, IoT equipment, etc.).

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An antenna device, comprising:
a Butler matrix, comprising an input terminal and an output terminal;
a switch, connected to the input terminal of the Butler matrix; and
an antenna module, comprising:
an antenna unit, connected to the output terminal;
a first guide, located on one side of the antenna unit; and
a second guide, located on other side of the antenna unit, wherein the antenna unit, the first guide, and the second guide are formed on a substrate.

2. The antenna device according to claim 1, wherein the substrate is a glass substrate, and the first guide and the second guide are formed on the substrate using a polysilicon thin film diode process.

3. The antenna device according to claim 1, wherein the antenna unit is at least part of a serial array antenna, a patch antenna, or a dipole antenna.

4. The antenna device according to claim 1, wherein the first guide comprises a first switch portion, the first guide is adapted to function as a director when the first switch portion is not conducting, and the first guide is adapted to function as a reflector when the first switch portion is conducting.

5. The antenna device according to claim 4, wherein the second guide comprises a second switch portion, the second guide is adapted to function as a director when the second switch portion is not conducting, and the second guide is adapted to function as a reflector when the second switch portion is conducting.

6. The antenna device according to claim 5, wherein the first switch portion and the second switch portion are PIN diodes or varactor diodes.

7. The antenna device according to claim 1, wherein the antenna unit has a first side and a second side opposite to each other and a third side and a fourth side opposite to each other, the first guide is located on the first side, the second guide is located on the second side, and the antenna unit is connected to the output terminal through a serial network located on the fourth side.

8. The antenna device according to claim 7, wherein the Butler matrix is adapted to control a beam in a first axial direction, and the first guide and the second guide are arranged in the first axial direction.

9. The antenna device according to claim 1, wherein the antenna unit has a first side and a second side opposite to each other and a third side and a fourth side opposite to each other, the first guide is located on the third side, the second guide is located on the fourth side, and the antenna unit is connected to the output terminal through a serial network located on the fourth side.

10. The antenna device according to claim 9, wherein the Butler matrix is adapted to control a beam in a first axial direction, the first guide and the second guide are arranged in a second axial direction, the second axial direction is perpendicular to the first axial direction, and the first guide and the second guide are adapted to control a beam in the second axial direction.
